(19) United States
(12) Patent Application Publication
(10) Pub. No.: US 2025/0238027 A1
(43) Pub. Date: Jul. 24, 2025

(54) INTELLIGENT MACHINE AUTOMATED CONTROL FOR PRODUCTION LINES

(71) Applicant: PHILIP MORRIS PRODUCTS S.A., Neuchatel (CH)

(72) Inventors: Mario Harz, Savigny (CH); Faizan Islam, Neuchatel (CH); Wojciech Szerlag, Neuchatel (CH); Josselin Vallee, Neuchatel (CH)

(21) Appl. No.: 18/852,585

(22) PCT Filed: Apr. 4, 2023
(86) PCT No.: PCT/EP2023/058855

§ 371 Date: Sep. 30, 2024

(30) Foreign Application Priority Data
Apr. 4, 2022 (EP) 22166529.2

(51) Int. Cl. G05B 19/418

(52) U.S. Cl. CPC G05B 19/41865; G05B 19/41885; G05B 2219/31412; G05B 2219/32304

(57) ABSTRACT

A method for controlling a production process is disclosed. The method comprises performing a simulation of a production process of a plurality of machines of a production line for a plurality of configurations of a speed management component, comprising, for each configuration, determining, by a simulation component, a plurality of statuses of the plurality of machines of the production line based on one or more events altering an operation state of the production line and based on speed set points for the plurality of machines, calculating, by a digital twin speed management component, at least one new speed set point for at least one machine of the plurality of machines of the production line, based on the determined plurality of statuses and the respective configuration used for the digital twin speed management component, and analysing performance of the production line based on speed set points for the plurality of machines, including the calculated at least one new speed set point for at least one machine of the plurality of machines, and, based on the analysis, deploying a configuration of the plurality of configurations of the speed management component for controlling the plurality of machines of the production line.

The present disclosure relates to control systems for production lines.

A production line comprises a plurality of machines that perform a set of sequential operations to produce a product. The behaviour of machines in a production line may change during runtime of the production line. In order to optimize a production performance of a production line, machine settings of machines in the production line can be changed. The machine settings may be changed manually. However, changes of machine settings of one machine in the production line may affect a plurality of machines in the production line, such as machines positioned downstream of the machine with the changed machine settings. Accordingly, manually changing machine settings of machines in the production line not only requires the availability of personnel, but also experienced personnel, in order to avoid a reduced production performance or downtime of machines in the production line.

According to an aspect of the present invention, a method for controlling a production process is provided. The method comprises performing a simulation of a production process of a plurality of machines of a production line for a plurality of configurations of a speed management component. The simulation of the production process comprises, for each configuration, determining, by a simulation component, a plurality of statuses of the plurality of machines of the production line based on one or more events altering an operation state of the production line and based on speed set points for the plurality of machines, and calculating, by a digital twin speed management component, at least one new speed set point for at least one machine of the plurality of machines of the production line, based on the determined plurality of statuses and the respective configuration used for the digital twin speed management component. The method further comprises analysing performance of the production line based on speed set points for the plurality of machines, including the calculated at least one new speed set point for at least one machine of the plurality of machines, and, based on the analysis, deploying a configuration of the plurality of configurations of the speed management component for controlling the plurality of machines of the production line.

By simulating a production process of a plurality of machines of a production line based on one or more events altering an operation state of the production line and based on speed set points for the plurality of machines, an improved speed management component for controlling machines in the production line can be deployed. The deployed speed management component may control machines of the production line considering events, such as stochastic events, and avoids manual interference with the production line. Thus, a self-adjusting control system is provided, which may provide for a plurality of advantages. For example, the deployed speed management component releases the operator from doing inefficient manual observance and control, provides for an intelligent production line requiring lesser manual intervention, optimizes a production performance of a production line with an increase of uptime and production of the production line, and reduces a not-at-target-rate loss and unplanned downtime of individual machines due to upstream and downstream failures of machines.

The present invention allows determining and testing configurations of the speed management component in a fast and efficient manner for determining a final version of a configuration of the speed management component, which can be used to control the machines of the production line. This is achieved by using a simulation and performing an analysis of the performance. Moreover, by using a simulation to test configurations of the speed management component, a safe method for testing configurations of the speed management component is provided, since the digital twin speed management component does not have an effect on the physical machines of the production line.

The results of the analysis of the performance of the digital twin speed management component interacting with the simulation component may be compared with a performance of a speed management component directly interacting with the machines of the production line. This allows finding improved configurations of a speed management component in a fast manner. In addition or alternatively, this allows the observation or classification of a performance of a speed management component currently interacting with the machines of the production line. Results of the comparison may be reported to a user.

According to another aspect of the present invention, a system configured for controlling a production process of a plurality of machines of a production line is provided. The system comprises a simulation component configured to simulate the production process for each configuration of a plurality of configurations of a speed management component by determining a plurality of statuses of the plurality of machines of the production line based on one or more events altering an operation state of the production line and based on speed set points for the plurality of machines. The system further comprises a digital twin speed management component configured to simulate the production process for each configuration of the plurality of configurations by calculating at least one new speed set point for at least one machine of the plurality of machines of the production line, based on the determined plurality of statuses and the respective configuration used for the digital twin speed management component. The system is configured to analyse a performance of the production line for each configuration of the plurality of configurations based on speed set points for the plurality of machines, including the calculated at least one new speed set point for at least one machine of the plurality of machines, and, based on the analysis, deploy a configuration of the plurality of configurations of the speed management component for controlling the plurality of machines of the production line.

This allows creating a self-adjusting control system based on data driven logic of machines. The speed management component may be capable of automatically adjusting and correcting in real time machine speed parameters of a production line or an Elementary Production Unit, EPU, in order to achieve a self-optimized manufacturing performance.

A self-adjusting control system, such as a speed management component, for a serial production line may create a steadiness between individual machines of the serial production line, ensuring that flow interruptions are reduced. By determining states of machines in the production line and automatically reacting, an improved self-adjusting control system for a self-optimized manufacturing performance of a complete serial production line, such as an EPU, is provided. This may significantly reduce the effort of manual observance of the production line.

The invention is defined in the claims. However, below there is provided a non-exhaustive list of non-limiting examples. Any one or more of the features of these examples may be combined with any one or more features of another example, embodiment, or aspect described herein.

Example Ex1: A method for controlling a production process, comprising: performing a simulation of a production process of a plurality of machines of a production line for a plurality of configurations of a speed management component, comprising, for each configuration, determining, by a simulation component, a plurality of statuses of the plurality of machines of the production line based on one or more events altering an operation state of the production line and based on speed set points for the plurality of machines; calculating, by a digital twin speed management component, at least one new speed set point for at least one machine of the plurality of machines of the production line, based on the determined plurality of statuses and the respective configuration used for the digital twin speed management component; and analysing performance of the production line based on speed set points for the plurality of machines, including the calculated at least one new speed set point for at least one machine of the plurality of machines. The method further comprises, based on the analysis, deploying a configuration of the plurality of configurations of the speed management component for controlling the plurality of machines of the production line.

Example Ex2: The method according to example Ex1, wherein a maximum buffer capacity of at least one machine of the production line is a configuration parameter for the plurality of configurations of the speed management component, and wherein the simulation of the production process of the plurality of machines of the production line is performed for a plurality of maximum buffer capacities of the at least one machine of the production line.

Example Ex3: The method according to example Ex1 or example Ex2, further comprising determining a dynamic optimal buffer capacity of at least one machine of the production line for the production process based on the simulation, by optimizing a maximum buffer capacity of the at least one machine with respect to at least one of 1) a level of micro-stops or speed mismatches of machines of the production line, 2) speed of machines of the production line, and 3) an operation phase, wherein the dynamic optimal buffer capacity changes over time based on the at least one of 1) an actual level of micro-stops or speed mismatches of machines of the production line, 2) speed of machines of the production line, and 3) an operation phase.

Example Ex4: The method according to example EX3, wherein the dynamic optimal buffer capacity of the at least one machine is not exceeding the maximum buffer capacity of the at least one machine.

Example Ex5: The method according to one of examples Ex1 to Ex4, wherein the simulation comprises a Markov-Chain Monte Carlo, MCMC, simulation.

Example Ex6: The method according to example Ex3, wherein machine learning is used to determine the dynamic optimal buffer capacity of the at least one machine.

Example Ex7: The method according to example Ex2 or Ex3, wherein the maximum buffer capacity of the at least one machine is a maximum buffer capacity of all machines of the production line.

Example Ex8: The method according to one of examples Ex1 to Ex7, wherein the at least one new speed set point for the at least one machine of the plurality of machines of the production line is obtained by the simulation component from the digital twin speed management component, such that the simulation component and the digital twin speed management component form a feedback loop.

Example Ex9: The method according to one of examples Ex1 to Ex8, wherein the simulation of the production process is performed in real-time.

Example Ex10: The method according to one of examples Ex1 to Ex9, wherein the digital twin speed management component is directly connected to the simulation component.

Example Ex11: The method according to one of examples Ex1 to Ex10, wherein at least one speed set point of the speed set points for the plurality of machines of the production line corresponds to target speeds of the plurality of machines.

Example Ex12: The method according to one of examples Ex1 to Ex11, wherein the plurality of statuses are determined based on at least one of:
a flow model for each machine of the plurality of machines describing a flow of materials from one machine or buffer to a next machine or next buffer of the production line,
a reliability model for each machine of the plurality of machines describing a time a machine is up or down, and
a quality model describing a quantity rejected by each machine of the plurality of machines due to quality issues.

Example Ex13: The method according to one of examples Ex1 to Ex12, wherein the flow model is a deterministic model.

Example Ex14: The method according to one of examples Ex1 to Ex13, wherein the reliability model is a statistical model.

Example Ex15: The method according to one of examples Ex1 to Ex14, wherein the quality model is a statistical model.

Example Ex16: The method according to one of examples Ex1 to Ex15, wherein the plurality of statuses comprises at least one of:
a speed of a machine of the plurality of machines,
a buffer level of a machine of the plurality of machines,
an efficiency of a machine of the plurality of machines,
a material list or process order, PO, message for a machine of the plurality of machines,
a parameter of a machine of the plurality of machines,
a material change for a machine of the plurality of machines, and
a failure of a machine of the plurality of machines.

Example Ex17: The method according to one of examples Ex1 to Ex16, wherein the one or more events comprise at least one of an operator stop for at least one machine of the plurality of machines, an unplanned stop of a machine of the plurality of machines, a lack or an excess of a product at an infeed or outfeed of a machine of the plurality of machines.

Example Ex18: The method according to one of examples Ex1 to Ex17, wherein the one or more events are one or more unplanned events occurring with a certain probability.

Example Ex19: The method according to one of examples Ex1 to Ex18, wherein the analysing the performance comprises analysing the performance with respect to at least one of an uptime of the plurality of machines, a production quantity of the plurality of machines, a not-at-target-rate loss of the plurality of machines and unplanned downtime of the plurality of machines.

Example Ex20: The method according to one of examples Ex1 to Ex19, further comprising: obtaining, by an aggregation server connected to the plurality of machines of the production line, a plurality of live statuses of the plurality of machines of the production line by aggregating machine data from the plurality of machines; calculating, by a speed management component connected to the aggregation server, at least one second speed set point for at least one machine of the plurality of machines of the production line, based on the plurality of live statuses; and controlling a speed of the at least one machine of the plurality of machines of the production line by setting the at least one second speed set point for the at least one machine of the plurality of machines of the production line.

Example Ex21: The method according to example Ex20, further comprising controlling, by the speed management component, a buffer level of at least one machine of the plurality of machines by calculating a speed set point for at least one machine of the plurality of machines based on at least one of 1) an actual level of micro-stops or speed mismatches of machines of the production line, 2) a speed of machines of the production line, and 3) an operation phase.

Example Ex22: The method according to one of examples Ex20 and Ex21, wherein the one or more events comprise one of:
machine stops from stochastic variables that have been previously estimated,
machine stops from stochastic variables that are being updated by the speed management component connected to the aggregation server connected to the plurality of machines,
actual machine stops as received from the speed management component connected to the aggregation server connected to the plurality of machines, and
machine stops retrieved from a file.

Example Ex23: The method according to one of examples Ex20 to Ex22, further comprising comparing a performance of the digital twin speed management component with a performance of a speed management component, and reporting on a result of the comparison.

Example Ex24: The method according to one of examples Ex20 to Ex23, wherein the controlling the speed of the at least one machine of the plurality of machines of the production line comprises adjusting a speed of a machine of the plurality of machines based on at least one of i) a status of a downstream machine positioned downstream of the machine of the production line and ii) a status of an upstream machine positioned upstream of the machine of the production line.

Example Ex25: The method according to one of examples Ex20 to Ex24, wherein controlling the speed of the at least one machine of the plurality of machines of the production line comprises controlling a speed of each machine of the plurality of machines to synchronize a speed of the plurality of machines.

Example Ex26: The method according to one of examples Ex20 to Ex25, wherein controlling the speed of the at least one machine of the plurality of machines of the production line comprises synchronously reducing a speed of the plurality of machines in case one machine has a failure.

Example Ex27: The method according to one of examples Ex20 to Ex26, wherein controlling the speed of the at least one machine of the plurality of machines of the production line comprises synchronously increasing a speed of the plurality of machines in case of start-up of the plurality of machines.

Example Ex28: The method according to one of examples Ex20 to Ex27, wherein controlling the speed of the at least one machine of the plurality of machines of the production line comprises synchronizing a speed of the plurality of machines in case one machine deviates from a target speed during a production process.

Example Ex29: The method according to one of examples Ex20 to Ex28, further comprising controlling, by the speed management component, buffer levels of at least one machine of the production line in accordance with a dynamic optimal buffer capacity of the at least one machine for a production process based on at least one of 1) a level of micro-stops or speed mismatches of machines of the production line, 2) speed of machines of the production line, and 3) an operation phase.

Example Ex30: A system configured for controlling a production process of a plurality of machines of a production line, wherein the system comprises a simulation component configured to simulate the production process for each configuration of a plurality of configurations of a speed management component by determining a plurality of statuses of the plurality of machines of the production line based on one or more events altering an operation state of the production line and based on speed set points for the plurality of machines, and a digital twin speed management component configured to simulate the production process for each configuration of the plurality of configurations by calculating at least one new speed set point for at least one machine of the plurality of machines of the production line, based on the determined plurality of statuses and the respective configuration used for the digital twin speed management component. The system is configured to analyse a performance of the production line for each configuration of the plurality of configurations based on speed set points for the plurality of machines, including the calculated at least one new speed set point for at least one machine of the plurality of machines, and, based on the analysis, deploy a configuration of the plurality of configurations of the speed management component for controlling the plurality of machines of the production line.

Example Ex31: The system according to example Ex30, wherein a maximum buffer capacity of at least one machine of the production line is a configuration parameter for the plurality of configurations of the speed management component, and wherein the simulation of the production process of the plurality of machines of the production line is performed for the plurality of configurations of the speed management component and for a plurality of maximum buffer capacities of the at least one machine of the production line.

Example Ex32: The system according to one of examples Ex30 and Ex31, wherein the system is configured to determine a dynamic optimal buffer capacity of at least one machine of the production line for the production process based on the simulation, by optimizing a maximum buffer capacity of the at least one machine with respect to at least one of 1) a level of micro-stops or speed mismatches of machines of the production line, 2) speed of machines of the production line, and 3) an operation phase, wherein the dynamic optimal buffer capacity changes over time based on the at least one of 1) an actual level of micro-stops or speed mismatches of machines of the production line, 2) speed of machines of the production line, and 3) an operation phase.

Example Ex33: The system according to example Ex32, wherein the dynamic optimal buffer capacity is not exceeding the maximum buffer capacity.

Example Ex34: The system according to one of examples Ex30 to Ex33, wherein the dynamic optimal buffer capacity is determined by using a Markov-Chain Monte Carlo, MCMC, simulation.

Example Ex35: The system according to one of examples Ex32 and Ex33, wherein artificial intelligence is used to determine the dynamic optimal buffer capacity.

Example Ex36: The system according to one of examples Ex30 to Ex35, further comprising an aggregation server configured to obtain a plurality of live statuses of the plurality of machines of the production line by aggregating machine data from the plurality of machines, and a speed management component configured to: receive, from the aggregation server, at least one live status of the plurality of live statuses; calculate, based on the at least one live status, at least one second speed set point for at least one machine of the plurality of machines of the production line; and control a speed of the at least one machine of the plurality of machines of the production line by setting the at least one second speed set point for the at least one machine of the plurality of machines of the production line.

Example Ex37: The system according to example Ex36, wherein the events comprise at least one of:
machine stops from stochastic variables that have been previously estimated,
machine stops from stochastic variables that are being updated by the speed management component connected to the aggregation server connected to the plurality of machines,
actual machine stops as received from the speed management component, and
machine stops retrieved from a file.

Example Ex38: The system according to one of examples Ex30 to Ex37, wherein each speed set point of the speed set points is received from the digital twin speed management component directly connected to the simulation component.

Example Ex39: The system according to one of examples Ex30 to Ex38, wherein the speed set points correspond to target speeds of the plurality of machines.

Example Ex40: The system according to one of examples Ex30 to Ex39, wherein the simulation component is configured to simulate the production process based on at least one of:
a flow model describing the flow of materials from one machine or buffer to a next machine or next buffer of the production line,
a reliability model describing a time a machine is up or down, and
a quality model describing a quantity rejected by each machine due to quality issues.

Example Ex41: The system according to example Ex40, wherein the flow model is a deterministic model.

Example Ex42: The system according to one of examples Ex40 and Ex41, wherein the reliability model is a statistical model.

Example Ex43: The system according to one of examples Ex40 to Ex42, wherein the quality model is a statistical model.

Example Ex44: The system according to one of examples Ex30 to Ex443, wherein the plurality of statuses comprises at least one of:
a speed of a machine of the plurality of machines,
a buffer level of a machine of the plurality of machines,
an efficiency of a machine of the plurality of machines,
a material list for a machine of the plurality of machines,
a parameter of a machine of the plurality of machines,
a material change for a machine of the plurality of machines, and
a failure of a machine of the plurality of machines.

Example Ex45: The system according to example Ex36, wherein the speed management component is configured to synchronize a speed of the plurality of machines.

Example Ex46: The system according to one of examples Ex36 and Ex45, wherein the speed management component is configured to synchronously reduce a speed of the plurality of machines in case one machine has a failure.

Example Ex47: The system according to one of examples Ex36, Ex45 and Ex46, wherein the speed management component is configured to synchronously increase a speed of the plurality of machines in case of start-up of the plurality of machines.

Example Ex48: The system according to one of examples Ex36, Ex45 to Ex47, wherein the speed management component is configured to synchronize a speed of the plurality of machines in case one machine deviates from a target speed during production.

Example Ex49: The system according to one of examples Ex36, Ex45 to Ex48, wherein the speed management component is configured to adjust a speed of a machine of the plurality of machines based on at least one of a status of a downstream machine positioned downstream of the machine of the production line and a status of an upstream machine positioned upstream of the machine of the production line.

Example Ex50: The system according to one of examples Ex30 to Ex49, wherein the simulation component is configured to simulate the production process in real-time.

Example Ex51: The system according to one of examples Ex30 to Ex50, wherein the events comprise at least one of an operator stop, an unplanned stop, a lack or an excess of a product at an infeed or outfeed of a machine.

Example Ex52: The system according to one of examples Ex30 to Ex51, wherein the digital twin speed management component and the simulation component are deployed in a container.

Example Ex53: The system according to one of examples Ex30 to Ex52, wherein the system comprises the plurality of machines of the production line, and wherein the plurality of machines comprise at least one of a crimper, a buffer, a combiner, a cut and turn unit, a packer line, a wrapper and a bundler.

Example Ex54: The system according to one of examples Ex36, Ex45 to Ex48, wherein the digital twin speed management component, the speed management component and the simulation component are executed as modules in a containerized environment on an edge device.

Example Ex55: The system according to one of examples Ex30 to Ex54, wherein the production line comprises an elementary production unit, EPU.

Example Ex56: The system according to one of examples Ex30 to Ex55, wherein open platform communication, OPC, unified architecture, UA, and tobacco machine communication, TMC, standards are used to interface and interact with the plurality of machines.

Examples will now be further described with reference to the figures in which:

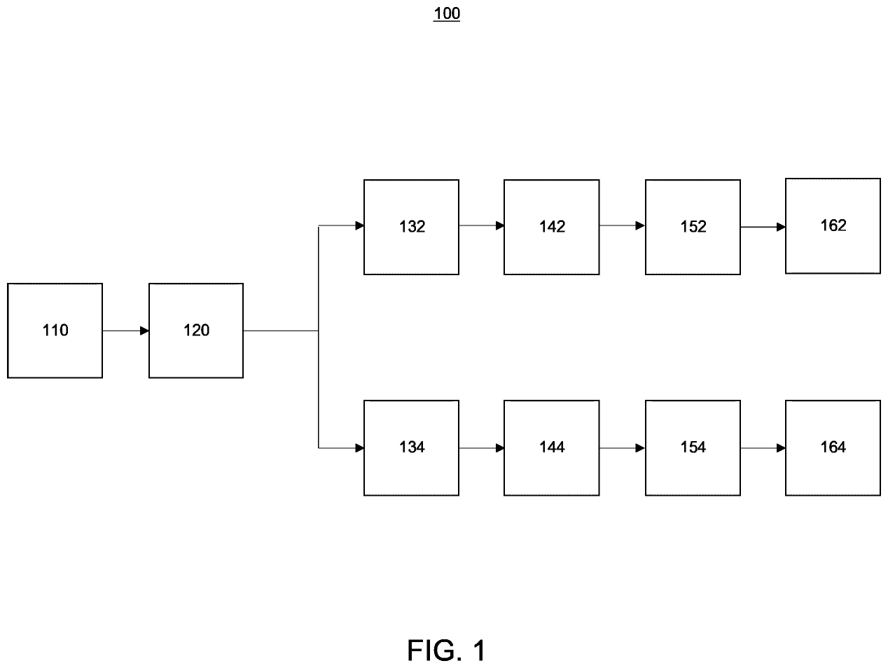

FIG. 1 shows a schematic example of machines of a production line;

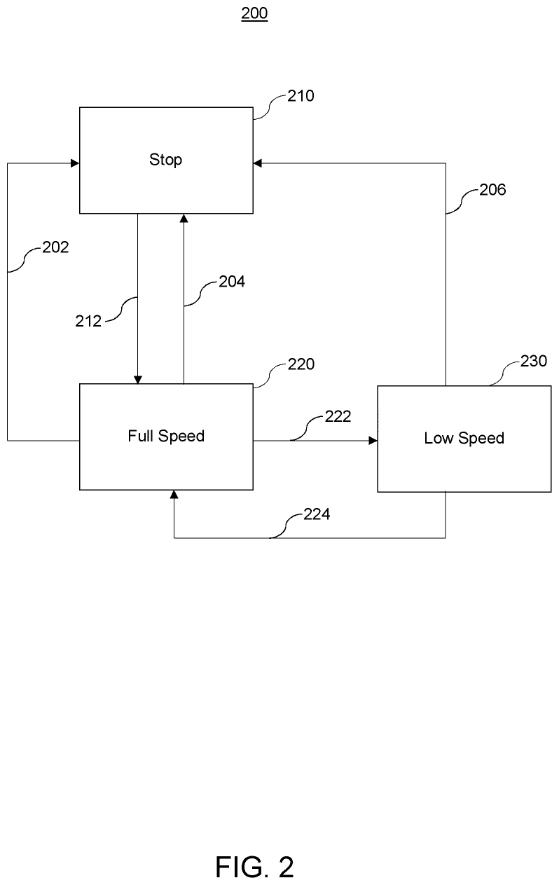

FIG. 2 shows an example diagram of a state machine for a machine;

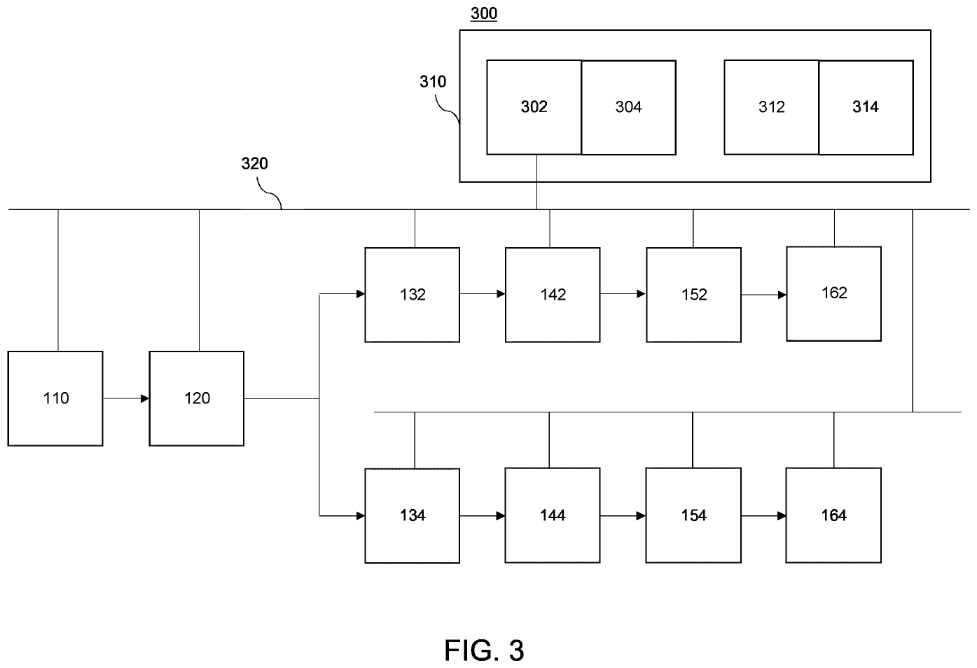

FIG. 3 shows an example architecture of a system for controlling a production process of a plurality of machines of a production line; and

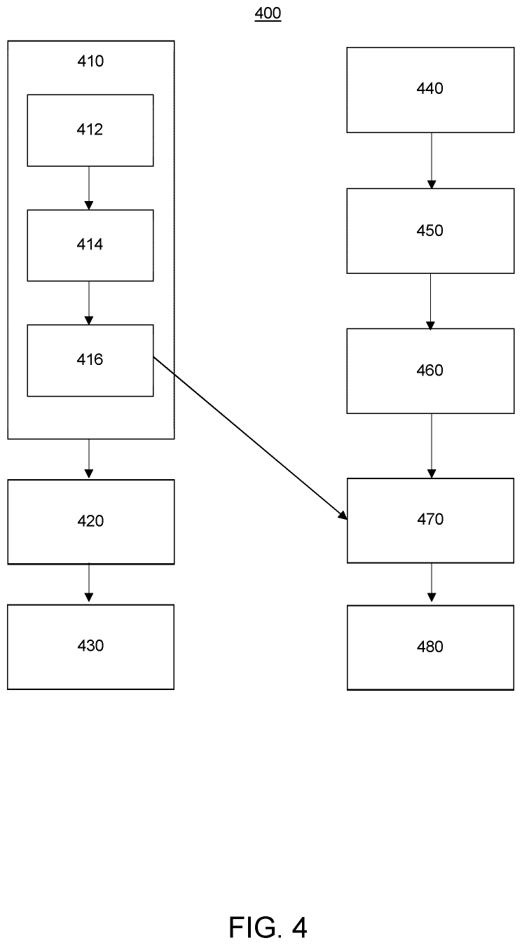

FIG. 4 shows a process flow diagram of a method for controlling a production process.

FIG. 1 illustrates a schematic example of a production line 100, which will also be referred to as an EPU in the description below. The production line may comprise two or more machines that perform a set of sequential operations to produce a product, such as an end or final product. Each of the machines may at least one of receive materials at an infeed of the respective machine and perform an operation, and may output a product, which may be received by a next machine in the production line 100.

A machine in the production line and states of this machine may be modelled by means of a state machine diagram. The state machine diagram of each individual machine of a production line may be used for a simulation of the production line. For example, a simulation model of the EPU may be constructed based on the state machines of machines of the EPU. The state machine diagrams may model the behaviour of a single object, such as machine speed specifying the different states of speed to which these machines can go during production, based on events.

The layout of the production line 100 is shown in FIG. 1. The production line comprises machines 110, 120, 132, 134, 142, 144, 152, 154, 162 and 164. Each machine may comprise one or more machines. The machines 110 to 164 of the production line may comprise Tobacco Machine Communication (TMC)-enabled machines. The arrows in FIG. 1 show the infeed and outfeed of each machine of production line 100. The transfer times of objects or goods from an outfeed of one machine to an infeed of the next machine may not be considered during normal production. These objects or goods transferred between machines may represent the passive capacity of the production line, which is always present during production.

Machine 110 may be a crimper. A crimper may be a combination of two sub-machines i.e. a Crimper Unit, CU, and a machine producing tobacco rods, which is the final output of the crimper. All stochastic stops due to a failure of the CU may also be observed on the machine producing the tobacco rods (as upstream machine stops). The crimper and the machine producing the tobacco rods can only run with the same speed. The crimper and the machine producing the tobacco rods can be modelled as one state machine, where states may change based on events, such as stochastic stops data. These stochastic stop data may include stops due to a failure of the CU or a failure of a loader for the machine 110. The final output from machine 110 may be tobacco rods, which are input to machine 120. Machine 120 may be a buffer.

In an example, the state machine of the machine 110 may comprise a first state, such as a crimper-stop-state, which corresponds to the machine state when it is stopped. Machine 110 can fall into this state because of the following conditions. A first condition may be that there is a stochastic stop on machine 110 (i.e. machine breakdown). This breakdown can also be due to upstream and downstream machine failure. The duration and occurrence timing of these stops may be simulated via a probabilistic generator. A second condition may be that there is a stop due to machine 120 becoming full. A second state of machine 110, such as a crimper-full-speed-state, may correspond to a state when machine 110 is running with production speed. A third state of machine 110, such as a crimper-low-speed-state, may correspond to a reduced production speed value. A fourth state of machine 110, such as a change-state, may be entered based on a quality of the product of the machine 110.

The infeed for machine 120, e.g. a buffer, may be a product, such as tobacco rods, from machine 110. The buffer may be set to a maximum buffer capacity. The maximum buffer capacity may correspond to the maximum amount of tobacco rods which the buffer can attain. This value may be predefined or set by a user.

The production line 100 may comprise three parts. A first part may comprise machines 110 and 120, a second part may comprise machines 132, 142, 152 and 162, and a third part may comprise machines 134, 144, 154 and 164. The second and the third part may represent a first and a second branch of the production line, which may share the product from the first part. Machines 132, 142, 152 and 162 may be of the same type as machines 134, 144, 154 and 164.

Machines 132 and 132 may be a combiner. An input to the combiner may be a product, such as tobacco rods, from the machine 120.

Machines of the production line may be represented by state machines comprising two or more states. For example, machine 132 may be represented by a state machine comprising four states, wherein each state of the four states corresponds to a different speed with which the machine 132 may be running. Each state of the state machines for a machine may be entered based on an event associated with the machine, such as a stochastic stop of the machine, or an event associated with another machine of the production line, such as an event of an upstream or downstream machine. Machines 142 and 144 may be buffers, machines 152 and 154 may be cut and turn units, and machines 162 and 164 may be a wrapper and bundler unit. The production process may be a process for producing a tobacco product.

According to one aspect, the production line may comprise a first production line comprising machine 110, such as a crimper, machine 132, such as a combiner, machine 152, such as a cut and turn unit, and machine 162, such as a wrapper and bundler unit, and a second production line comprising machine 110, such as a crimper, machine 134, such as a combiner, machine 154, such as a cut and turn unit, and machine 164, such as a wrapper and bundler unit. This production line may perform a production process without a buffer between at least one of machines 110 and 132, 110 and 134, 132 and 152, and 134 and 154.

According to an aspect, the production line may comprise only one production line comprising machine 110, such as a crimper, machine 132, such as a combiner, machine 152, such as a cut and turn unit, and machine 162, such as a wrapper and bundler unit. This production line may perform a production process without a buffer between machines 110 and 132. Additionally or alternatively, this production line may perform a production process without a buffer between machines 132 and 152.

According to an aspect, the production line may comprise machine 110, such as a crimper, machine 132, such as a combiner, machine 142, such as a buffer, machine 152, such as a cut and turn unit, and machine 162, such as a wrapper and bundler unit. This production line may perform a production process without a buffer between machines 110 and 132.

According to one aspect, the production line may comprise a first production line comprising machine 110, such as a crimper, machine 132, such as a combiner, machine 142, such as a buffer, machine 152, such as a cut and turn unit, and machine 162, such as a wrapper and bundler unit, and a second production line comprising machine 110, such as a crimper, machine 134, such as a combiner, machine 144, such as a buffer, machine 154, such as a cut and turn unit, and machine 164, such as a wrapper and bundler unit. This production line may perform a production process without a buffer between at least one of machines 110 and 132, and machines 110 and 134.

FIG. 2 illustrates an example diagram of a state machine 200 for a machine, such as machine 152, of the production line. The state machine diagram 200 may comprise a first state 210 corresponding to the state when machine 152 is stopped. Machine 152 may enter this state from one of states 220 and 230. For example, machine 152 may enter this state based on a first event, such as a machine breakdown of machine 152 or a failure of an upstream machine, such as machine 142, or an downstream machine, such as machine 162. When simulating the behaviour of machine 152, the first event may be simulated by a probabilistic generator. The probabilistic generator may simulate the duration and occurrence timing of the first event. Arrows 202 and 206 in the state machine represent occurrence of the first event. A second event may occur due to a missing product from an upstream machine, such as machine 142. Arrow 204 in the state machine 200 represents occurrence of the second event. State 220 may correspond to a state in which machine 152 is running at a target speed of the machine 152. Arrow 212 may represent a start or restart of machine 152. The production speed of machine 152 may be synchronized with the infeed or the speed of another machine, such as machine 162. For example, if machine 162 (the machine downstream to machine 152) is run at a low speed, the speed of machine 152 may be reduced by entering the state 230 (see arrow 222). Similarly, the speed of machine 152 may be increased from the low speed state 230 to the state 220 (see arrow 224).

FIG. 3 shows an example architecture of a system 300 for controlling a production process of a plurality of machines 110 to 164 of a production line. System 300 may comprise the machines 110 to 164 of a production line, and an edge device 310. All machines 110 to 164 of the production line may be connected with the edge device 310. The system 300 comprises a simulation component 312 configured to simulate the production process for each configuration of a plurality of configurations of a speed management component 304 by determining a plurality of statuses of the plurality of machines 110 to 164 of the production line based on one or more events altering an operation state of the production line and based on speed set points for the plurality of machines 110 to 164. The system 300 further comprises a digital twin speed management component 314 configured to simulate the production process for each configuration of the plurality of configurations by calculating at least one new speed set point for at least one machine of the plurality of machines 110 to 164 of the production line, based on the determined plurality of statuses and the respective configuration used for the digital twin speed management component 314. A performance of the production line for each configuration of the plurality of configurations may be analysed based on speed set points for the plurality of machines 110 to 164, including the calculated at least one new speed set point for at least one machine of the plurality of machines. Based on the analysis, a configuration of the plurality of configurations of the speed management component 304 is deployed for controlling the plurality of machines 110 to 164 of the production line. The digital twin speed management component 314 is directly connected to the simulation component 312. Each speed set point of the speed set points used by the simulation component 312 may be received from the digital twin speed management component 314.

System 300 may further comprise an aggregation server 302 and speed management component 304. The aggregation server 302 is configured to obtain a plurality of live statuses of the plurality of machines 110 to 164 of the production line by aggregating machine data from the plurality of machines. This may be done via the bus 320. The speed management component 304 may be configured to: receive, from the aggregation server 302, at least one live status of the plurality of live statuses; calculate, based on the at least one live status, at least one second speed set point for at least one machine of the plurality of machines 110 to 164 of the production line; and control a speed of the at least one machine of the plurality of machines 110 to 164 of the production line by setting the at least one second speed set point for the at least one machine of the plurality of machines 110 to 164 of the production line.

The digital twin speed management component 314, the speed management component 304 and the simulation component 312 may be executed as modules in a containerized environment on the edge device 310. Open platform communication, OPC, unified architecture, UA, and tobacco machine communication, TMC, standards may be used to interface and interact with the plurality of machines 110 to 164.

Each machine of machines 110 to 164 may comprise a server such as a TMC OPC UA Server, TMC-S, running as a module on the respective machine in a containerized environment. In this way, parameters of the machines will be accessible for reading and writing. This allows the development and continuous improvement of control mechanisms without involvement of the Original Equipment Manufacturer, OEM. In addition, the aggregation server 302, such as a TMC OPC UA Aggregation Server, TMC-AS, is running as a module on the Edge device in a containerized environment. TMC-AS may serve as a client for all TMC-Ses of the machines 110 to 164, consolidating the servers of the machines controlled by Speed Management.

The simulation component 312, also referred to as Real time Probabilistic Simulator, TMC-AS DT, in this description, may be a first micro-service running on the existing Edge device in a containerized environment. The digital twin speed management component 314, as well as the speed management component 304, also referred to as Speed Management Controller, SM, may be a second micro-service running on the existing Edge device in a containerized environment.

Real time Probabilistic Simulator, TMC-AS DT, is coded as a replica of the group of machines 110 to 164, and may be validated against actual production time series. The TMC-AS DT may comprise a deterministic state machine for the product flow, while other relevant production events are statistically modelled and inferred from machine data.

The TMC-AS DT may be regarded as the aggregation server 302, such as a TMC Aggregation Server, where the instances of the following TMC types and their connections to the underlying system are replaced by a dynamic simulation where quantities are varied over time based on machine module speed. The simulation comprises that 1) the loaded materials for the machines are consumed (deterministically) according to the machine speed and status, and material list information, 2) the output quantity is computed (deterministically) as a function of the machine set speed and material list information, where speed ramp-ups and ramp-down are simulated with the machine state changes, and 3) the material quantity in the buffer is updated (deterministically) as a combined result of material incoming/outgoing. The status of the machines may be simulated over time stochastically, i.e. by emulating the random behaviour of unplanned machine stops. The state machine for the machines of the production line may be driven by stochastic events.

A complete data-set for one production shift time period from an actual group of production machines may be used for the simulation. Further, machined stops may be classified into stop classes. For each stop class and all stops, the frequencies may be inferred into probability functions for Mean Time Between Failures, MTBF, and Mean Time to Recovery, MTTR. Events may be drawn from such distributions to change the machine status in the simulation, thus causing the deterministic part of the model to follow. For example, if an operator stop occurs on average after 48 minutes of uninterrupted machine production and the machine returns to its normal production status in 2 minutes, then stop and restart events are drawn from a suitable random variable matching the measured averages. In aggregate, i.e. over a long enough time period of operation, the TMC-AS DT is expected to behave as the actual group of machines for a production shift, i.e. achieve a very similar production level and similar downtimes. The TMC-AS DT Micro-Service may be deployed as a container. The containerized image of the TMC-AS DT may be deployed to the target Edge device 310.

During development of the Speed Management Controller, SM, such as speed management component 304, a configuration of the speed management component 304 in the form of digital twin speed management component 314 may be tested in terms of performance against the TMC-AS DT without impact on operations of the physical machines 110 to 164. Simulations for different configurations of the speed management component 304 in the form of digital twin speed management component 314 may be iterated so that a satisfactory performance level is achieved during the simulation. The final accepted version may be deployed and timed to the physical group of machines 132 to 164 in operation. Speed management component 304 may be regarded as a deployed version of the digital twin speed management component 314.

Speed Management Controller, SM, Micro-Service may be developed to synchronize the speed of machines or machine modules of the TMC-AS checking the status of buffers (if any) and machine efficiency. Machine modules may include machine buffers within a machine. More specifically, the SM may be a modular micro-service that adjusts the upstream and downstream speeds in reaction to the buffer levels and machine efficiency as well as issue commands for the automatic start-up of machines. The intensity of the feedback and feedforward loops may be adjustable and may be set by a user.

TMC-AS DT and SM micro-services may interact with the TMC OPC UA Aggregation Server, TMC-AS, for the purpose of reading/writing information from/to the TMC OPC UA Server, TMC-S, of machines 132 to 164. TMC-AS DT and SM micro-services may require publishing real time values and events information of the system 300 to a historian.

The Real time Probabilistic Simulator, TMC-AS DT, in the final implemented version will serve the purpose of defining what EPU performance would have been without Speed Management implementation. This definition will be necessary to compare the performance improvement on the EPU with the speed management solution. The Real time Probabilistic Simulator, TMC-AS DT, will receive from and send to the EPU TMC OPC UA Aggregation server (implemented under the scope of EPU Digital Foundation) the following:

### Receive:

1. EPU machine values by OPC UA (client/server) communication
2. process order (PO) message (material list) by OPC UA (client/server) communication.

### Send:

1. Time Series and Log information by OPC UA (client/server) communication.

The Speed Management Controller (speed management component 304) in the final implemented version will serve the purpose of controlling EPU machines via the EPU TMC OPC UA Aggregation server (implemented under the scope of the EPU Digital Foundation). In the final implemented version of the SM controller, part of TMC-AS DT (312 and 314) logic will also be embedded. This will be the logic of predictive analysis that the SM controller will require in order to independently predict and control EPU machines. The Speed Management Controller (speed management component 304) will receive from and send to the EPU TMC OPC UA Aggregation server (implemented under the scope of EPU Digital Foundation) the following:

### Receive:

1. EPU machine values by OPC UA (client/server) communication, and
2. Process order (PO) message (material list) by OPC UA (client/server) communication.

### Send:

1. Time Series and Log information by OPC UA (client/server) communication, and
2. EPU machine values to be by OPC UA (client/server) communication.

A process order, PO, message may be sent to a machine before the beginning of production. It contains a description of which brand, which market the volume is produced for, and how much volume should be produced under this PO, etc. This is an additional check, because in certain formats the maximum speed may differ. For example, if there is a format in which inserts have to be included in packs, the maximum speed of the machine has to be lower. Therefore, PO messages provide for a cross-check.

Speed Management Controller logic (speed management component 304) may be developed by using the Real time Probabilistic Simulator, TMC-AS DT. This controller logic will be developed targeting the following aspects and improvement features for the EPU.

The SM logic comprises a combination of deterministic self-adjusting control loops which will observe the performance of the EPU machines during production. These observations may be based upon the machine status information that may be received via Machine Integration. Based on these observations, the SM logic will impose variations on the EPU machines in order to get the optimum performance from the EPU under existing circumstances during production. In addition, SM logic may be developed to balance the speed of Machine Modules of the TMC-AS checking the status of buffers (if any) and machine efficiency. Based on the devised SM logic, a comparison analysis may be performed for the EPU for different configurations of the speed management components or with versus without SM logic. Based on the outcome of this analysis, SM logic may be deployed or further improved. The analysis may comprise determining performance indicators, such as an uptime increase of the machines, a production increase, a not-at-target-rate loss, and an amount of unplanned downtime due to upstream and downstream failures.

EPU speed synchronization is a feature provided by Speed Management controller (304). Speed management component 304 may ensure a synchronous ramp-down of all machines in the production line in case one machine has a failure. Similarly, speed management component 304 may ensure synchronous start-up (i.e. ramp-up) to target speed of all machines once the failure at the machine is resolved. In order to create synchronous ramp-down and synchronous start-up behaviour, an automatic restart and standby feature may be present on the machines.

In addition, the speed management component 304 may ensure synchronization of speed of all machines during runtime, in case one machine deviates from target speed during production. For example, if there is a speed reduction on a packer due to the event of material change, then the remaining EPU machines will synchronize their speed in order to achieve a balance on the complete EPU line.

The production speed acceleration and deceleration capability of EPU machines may be non-identical. Therefore, speed management component 304 may synchronize machine speeds considering acceleration and deceleration capabilities of the machines in order to avoid additional process stops during ramp-down, start-up and speed reduction of machines.

A different amount of buffer storage capacities in the production line may be analysed based on a performance of the SM (speed management component 314) with respect to the capabilities of the EPU machines.

Under the existing capabilities of EPU machines, a particular amount of buffer storage capacity may be necessary. This is because EPU machines will always have a speed acceleration and deceleration, and the value of acceleration and deceleration of different EPU machines is non-identical. Therefore, not having this particular amount of buffer storage capacity would result in stops, due to lack or excess of product at the infeed or outfeed of machines.

A maximum capacity of a buffer in the production line may be controlled by the system. The maximum capacity may be a parameter of the system. The SM controller (speed management component 304) may be configured to optimize the production line using a maximum buffer usage value based on technical limitations of the EPU machines.

For example, a maximum capacity of a buffer (machine 142) is 25% and its active capacity is 10%. If CTU (machine 152) has a failure in this situation, then combiner (machine 132) will run (with speed management component 304) until the buffer capacity has reached 25% (while CTU still has a failure). Then the combiner will go to standby due to the downstream machine 142.

Optimization analysis of buffer minimization utilization may be performed with reference to the impact it has on the performance of EPU machines with Speed Management controller (digital twin speed management component 314). Accordingly, the impact of buffer reduction may be evaluated by using simulation of machines using key performance indicators (KPIs). This evaluation may be provided as a report. The value of a maximum capacity of buffer storage may be determined based on the outcome of this evaluation. The maximum capacity of the production line may be a configuration parameter of the controller.

The machines 132 to 164 may be controlled by the speed management component 304 and may be connected to the bus 320. Additionally, at least one of materials and products may flow from one machine to a next machine in the production line to make one final product.

In FIG. 3, the simulation component 312 and the digital twin speed management component 314 may be regarded as a digital system, since they do not act on the physical machines 110 to 164. The aggregation server 302 and the speed management component 304 may be regarded as a physical system, since they do act on the physical machines 110 to 164. The simulation component 312 may clone the interface of the aggregation server 302. The aggregation server 302 aggregates live data of the machines 110 to 164. The speed management component 304 receives the live data of the machines 110 to 164 or statuses of the machines 110 to 164, where the statuses are based on the live data of the machines 110 to 164. The aggregation server 302 receives data, such as speed set points for Machines or KPIs, from the speed management component 304. The digital twin speed management component 314 receives simulated data of the machines 110 to 164 or simulated statuses of the machines 110 to 164 from the simulation component 312. Alternatively, the digital twin speed management component 314 receives the live data of the machines 110 to 164 or the live statuses of the machines 110 to 164. The simulation component 312 receives data, such as speed set points for machines or KPIs, from the digital twin speed management component 314.

The digital twin speed management component 314 and the speed management component 304 acquire information (simulated or live) from the machines 110 to 164. Based on the acquired information, the digital twin speed management component 314 and the speed management component 304 estimate 1) a status of the flow model (where materials are) and 2) internal statistical parameters for the machine reliability model (defining MTBF/MTTR) and quality model (defining rejects).

The digital twin speed management component 314 and the speed management component 304 supports 1) single link-up mode and 2) double link-up mode. In single link-up mode, either the second part comprising machines 132, 142, 152 and 162 or the third part comprising machines 134, 144, 154 and 164 are in operation. In double link-up mode, both second and third parts are in operation. The mode may be selected by a user or a control system.

In double link-up mode, the bottleneck of the production line may be the crimper. A minute of production lost at the bottleneck cannot be recovered anywhere else in the production line. The flow coming from the buffer after the crimper may be split into two flows (to the second part and the third part) proportional to the line efficiency. The line efficiency may be continuously updated based on downtime data coming from the machines. If the efficiency of one part of the line deteriorates over time, it may proportionally receive less flow.

In single link-up mode, the bottleneck may be the packer. In both single link-up mode and double linkup mode, digital twin speed management component 314 and the speed management component 304 computes speed set points of a machine based on the upstream and downstream status of machines, which will be referred to as the Machine-to-Machine, M2M, logic.

The M2M logic works as follows: 1) If the upstream machine is down, the speed of the machine is reduced to avoid starving. Digital twin speed management component 314 or speed management component 304 consider the upstream reservoir (either a buffer or the in-between-machines product) and the next predicted failure. The next predicted failure is based on the machine reliability model, which may be built on real machine data and may constantly be updated as machine stop data is collected. 2) If the upstream machine is running, digital twin speed management component 314 or speed management component 304 computes the optimal buffer level that will avoid blocking or starving the machine until the next predicted failure event of either the machine or the upstream one. In order to achieve the optimal buffer level, digital twin speed management component 314 or speed management component 304 compute the speed set point for the machine considering the upstream machine speed.

Digital twin speed management component 314 or speed management component 304 may apply the M2M logic starting from the last machine of the production line and may proceed backwards to the infeed machine. The pass on the line may be run backwards because blockages are not very likely, so that a downstream machine failure does not vary the upstream machine speed.

The simulation component 312 may be a containerized application that simulates the behaviour of an EPU. This means that the simulation component 312 simulates the status of the machines, including uptime and downtime, their speed and the level of the buffers, so that input materials consumption and output material production is available. The simulation component 312 may be regarded as a digital replica of the real EPU, which is why it is called Digital Twin (DT).

The DT may work in different modes:

1. FixedStochastic-mode: the DT simulates the process drawing machine stops from stochastic variables that have been previously estimated. Each machine speed set point is received from the digital twin speed management component 314 directly connected to the DT, otherwise the target speed may be used.

2. UpdatedStochastic-mode: the DT simulates the process drawing machine stops from stochastic variables that are being updated by the speed management component 304 connected to the Aggregation Server. Each machine speed set point is received from the digital twin speed management component 314 directly connected to the DT, otherwise the target speed may be used.

3. Live-mode: the DT simulates the process with the actual machine stops as received from the speed management component 304 connected to the aggregation server 302. Each machine speed set point is received from the digital twin speed management component 314 directly connected to the DT, otherwise the target speed is used.

4. FromFile-mode: the DT simulates the process with the machine stops retrieved from a file. Each machine speed set point is received from the digital twin speed management component 314 directly connected to the DT, otherwise the target speed is used.

The Live mode may be used to run a what-if scenario on-line, i.e. while the EPU is producing, but with a different speed management component 304 or with no speed management component 304 at all. The what-if scenario is helpful for comparing and contrasting performance with different control strategies, i.e. different speed control algorithms that speed management component 304 implements.

The FixedStochastic mode may be used to generate off-line simulations to debug and assess the expected performance of a configuration of the speed management component 304.

DT implements a production system combining machines, software components that perform product processing functions, and buffers, software components holding a reservoir of product. Such a production system is non-trivial. The DT may implement a Monte-Carlo simulation approach.

For each machine, the DT (simulation component 312) may implement 1) a flow model, i.e. a deterministic model describing the flow of material from the previous buffer or machine to the next buffer or machine, 2) a reliability model, i.e. a statistical model describing the time a machine is up/down, and 3) a quality model, i.e. a statistical model describing the quantity rejected by each machine due to quality issues.

The flow model may also implement back-flow, i.e. a flow interruption when a machine is starved (no input material from the empty upstream buffer) or blocked (no output material to the downstream full buffer). Starved and blocked events are also called external stops and are the main focus of reduction for speed management component 304.

The DT exposes the same OPC UA interface that the Aggregation Server exposes, so that a containerized speed management component 304 or digital twin speed management component 314 can either be connected with an Aggregation Server connected to the real EPU or to the DT, without any modification. The advantage of exposing the same interface is that digitally a management component can be tuned off-line and, when performance is satisfactory, used on-line without touching it, which would make the on-line and off-line performance not fully comparable.

FIG. 4 illustrates a process flow diagram of a method 400 for controlling a production process. The method 400 comprises the step 410 of performing a simulation of a production process of a plurality of machines of a production line for a plurality of configurations of a speed management component. The simulation may comprise, for each configuration: determining, by a simulation component, a plurality of statuses of the plurality of machines of the production line based on one or more events altering an operation state of the production line and based on speed set points for the plurality of machines (step 412); calculating, by a digital twin speed management component, at least one new speed set point for at least one machine of the plurality of machines of the production line, based on the determined plurality of statuses and the respective configuration used for the digital twin speed management component (414); and analyzsing performance of the production line based on speed set points for the plurality of machines, including the calculated at least one new speed set point for at least one machine of the plurality of machines (step 416). In examples, step 416 may not be a part of the simulation.

In step 420, a configuration of the plurality of configurations of the speed management component is deployed for controlling the plurality of machines of the production line based on the analysis.

In step 430, a dynamic optimal buffer capacity of at least one machine of the production line for the production process is determined based on the simulation, by optimizing a maximum buffer capacity of the at least one machine with respect to at least one of 1) a level of micro-stops or speed mismatches of machines of the production line, 2) speed of machines of the production line, and 3) an operation phase, wherein the dynamic optimal buffer capacity changes over time based on the at least one of 1) an actual level of micro-stops or speed mismatches of machines of the production line, 2) speed of machines of the production line, and 3) an operation phase.

Additionally, the method 400 may comprise a method of controlling a speed of at least one machine of the production line. The method of controlling a speed of at least one machine of the production line comprises steps 440 to 460. In step 440, a plurality of live statuses of the plurality of machines of the production line is obtained by aggregating machine data or live data from the plurality of machines. An aggregation server, such as aggregation server 302, connected to the plurality of machines of the production line may perform step 440. In step 450, at least one second speed set point for at least one machine of the plurality of machines of the production line is calculated, based on the plurality of live statuses. A speed management component, such as speed management component 304, connected to the aggregation server, may perform step 450. In step 460, a speed of the at least one machine of the plurality of machines of the production line is controlled by setting the at least one second speed set point for the at least one machine of the plurality of machines of the production line. The speed management component may perform step 460.

At step 470, the method 400 comprises comparing a performance of the digital twin speed management component with a performance of the speed management component, and at step 480, the method comprises reporting on a result of the comparison. The result of the comparison may affect the deployment in step 420. For example, a configuration of the plurality of configurations of the speed management component is deployed for controlling the plurality of machines of the production line based on the analysis and a result of the comparison. A configuration of the plurality of configurations of the speed management component may only be deployed if the configuration of the speed management component improves at least one of the efficiency and performance of the production line.

Accordingly, a configuration of a plurality of configurations of a speed management component can be tested by using this configuration for the digital twin speed management component interacting with the simulation component. This does not have an effect on the machines of the production line. If the configuration satisfies requirements, this configuration can be used for the speed management component interacting with the aggregation server and the machines of the production line. For example, the configuration may be deployed to the edge device or the production line for controlling the machines of the production line.

The simulation component may be validated. An offline version of the simulation component after validation may be used to create several different versions or configurations of speed management controller and tested with the simulation component by using historical production data from a production line. During development, there may not be an impact on physical machines. The final accepted version or configuration of speed management controller based on its improvements may be finalized or deployed on a gateway (an edge device in a containerized environment) by an SRE, Site Reliability Engineer. The terms “speed management controller” and “speed management component” may be used interchangeably in this description.

During the development of speed management controller versions or configurations, a request from a user may be to see the impact when reduced fill levels of buffers are used as their maximum capacity during production. This analysis may be performed at the time when different speed management controller versions or configurations were created before a final version or configuration is selected.

One additional feature of speed management controller is that whatever the reduced capacity of a buffer as a maximum capacity is, the speed management controller (while running on the edge device) observes the previous running efficiency of machines and the predictability of machines and, based thereon, adjusts the current fill level of the buffer (which should be within the new defined maximum fill level of the buffer) to minimize the dependency between machines.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above, provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

The specific embodiments and examples described above illustrate but do not limit the invention. It is to be understood that other embodiments of the invention may be made and the specific embodiments and examples described herein are not exhaustive.

As used herein, the terms “upstream” and “front”, and “downstream” and “rear”, are used to describe the relative positions or modules of the machines in the production line in relation to the direction in which products “flow” or move through the production line.

An object of the present invention is to create a self-adjusting control system based on data driven logic of machines. The system may be capable of automatically adjusting and correcting in real time machine speed parameters of an Elementary Production Unit (EPU) in order to achieve a self-optimized manufacturing performance.

During production on the shop floor, the process of manual adjustment of machine parameters according to the performance of machines requires manual observance. Further, the process of manual adjustment depends on the experience and availability of personnel on the machine. This leads to a potential loss of production performance and time spent by personnel in an inefficient activity. However, a self-adjusting control system, such as a speed management system, for a serial production line may create a steadiness between individual machines of the serial production line ensuring that flow interruptions are reduced. By determining states of machines in the production line and automatically reacting, an improved self-adjusting control system for a self-optimized manufacturing performance of a complete serial production line, such as an EPU, is provided. This may significantly reduce the effort of manual observance of the production line.

1-15. (canceled)

16. A method for controlling a production process, comprising:
performing a simulation of a production process of a plurality of machines of a production line for a plurality of configurations of a speed management component, comprising, for each configuration:
determining, by a simulation component, a plurality of statuses of the plurality of machines of the production line based on one or more events altering an operation state of the production line and based on speed set points for the plurality of machines;
calculating, by a digital twin speed management component, at least one new speed set point for at least one machine of the plurality of machines of the production line, based on the determined plurality of statuses and the respective configuration used for the digital twin speed management component; and
analysing performance of the production line based on speed set points for the plurality of machines, including the calculated at least one new speed set point for at least one machine of the plurality of machines; and
based on the analysis, deploying a configuration of the plurality of configurations of the speed management component for controlling the plurality of machines of the production line,
wherein the method further comprises:
obtaining, by an aggregation server connected to the plurality of machines of the production line, a plurality of live statuses of the plurality of machines of the production line by aggregating machine data from the plurality of machines;
calculating, by the speed management component connected to the aggregation server, at least one speed set point for at least one machine of the plurality of machines of the production line, based on the plurality of live statuses; and
controlling a speed of the at least one machine of the plurality of machines of the production line by setting the at least one speed set point for the at least one machine of the plurality of machines of the production line, and
wherein the one or more events comprise one of:
actual machine stops as received from the speed management component connected to the aggregation server connected to the plurality of machines, and
machine stops from stochastic variables that are being updated by the speed management component connected to the aggregation server connected to the plurality of machines.

17. The method of claim 16, wherein a maximum buffer capacity of at least one machine of the production line is a configuration parameter for the plurality of configurations of the speed management component, and wherein the simulation of the production process of the plurality of machines of the production line is performed for a plurality of maximum buffer capacities of the at least one machine of the production line.

18. The method of claim 16, further comprising determining a dynamic optimal buffer capacity of at least one machine of the production line for the production process based on the simulation, by optimizing a maximum buffer capacity of the at least one machine with respect to at least one of 1) a level of micro-stops or speed mismatches of machines of the production line, 2) speed of machines of the production line, and 3) an operation phase, wherein the dynamic optimal buffer capacity changes over time based on the at least one of 1) an actual level of micro-stops or speed mismatches of machines of the production line, 2) speed of machines of the production line, and 3) an operation phase.

19. The method of claim 16, wherein the plurality of statuses are determined based on at least one of:
a flow model for each machine of the plurality of machines describing a flow of materials from one machine or buffer to a next machine or next buffer of the production line,
a reliability model for each machine of the plurality of machines describing a time a machine is up or down, and
a quality model describing a quantity rejected by each machine of the plurality of machines due to quality issues.

20. The method of claim 16, wherein the plurality of statuses comprise at least one of:
a speed of a machine of the plurality of machines,
a buffer level of a machine of the plurality of machines,
an efficiency of a machine of the plurality of machines,
at least one of a material list and a process order, PO, message for a machine of the plurality of machines,
a parameter of a machine of the plurality of machines,
a material change for a machine of the plurality of machines, and
a failure of a machine of the plurality of machines.

21. The method of claim 16, wherein the one or more events comprise at least one of one or more unplanned events occurring with a certain probability, an operator stop for at least one machine of the plurality of machines, an unplanned stop of a machine of the plurality of machines, a lack or an excess of a product at an infeed or outfeed of a machine of the plurality of machines, machine stops from stochastic variables that have been previously estimated, and machine stops retrieved from a file.

22. The method of claim 16, further comprising comparing a performance of the digital twin speed management component with a performance of the speed management component; and
reporting on a result of the comparison.

23. A system configured for controlling a production process of a plurality of machines of a production line, wherein the system comprises:
a simulation component configured to:
simulate the production process for each configuration of a plurality of configurations of a speed management component by determining a plurality of statuses of the plurality of machines of the production line based on one or more events altering an operation state of the production line and based on speed set points for the plurality of machines;
a digital twin speed management component configured to:
simulate the production process for each configuration of the plurality of configurations by calculating at least one new speed set point for at least one machine of the plurality of machines of the production line, based on the determined plurality of statuses and the respective configuration used for the digital twin speed management component;
an aggregation server configured to obtain a plurality of live statuses of the plurality of machines of the production line by aggregating machine data from the plurality of machines; and
the speed management component configured to:
receive, from the aggregation server, at least one live status of the plurality of live statuses;
calculate, based on the at least one live status, at least one speed set point for at least one machine of the plurality of machines of the production line; and
control a speed of the at least one machine of the plurality of machines of the production line by setting the at least one speed set point for the at least one machine of the plurality of machines of the production line,
wherein the one or more events comprise one of:
actual machine stops as received from the speed management component connected to the aggregation server connected to the plurality of machines, and
machine stops from stochastic variables that are being updated by the speed management component connected to the aggregation server connected to the plurality of machines, and
wherein the system is configured to:
analyse a performance of the production line for each configuration of the plurality of configurations based on speed set points for the plurality of machines, including the calculated at least one new speed set point for at least one machine of the plurality of machines; and
based on the analysis, deploy a configuration of the plurality of configurations of the speed management component for controlling the plurality of machines of the production line.

24. The system of claim 23, wherein a maximum buffer capacity of at least one machine of the production line is a configuration parameter for the plurality of configurations of the speed management component, and wherein the simulation of the production process of the plurality of machines of the production line is performed for the plurality of configurations of the speed management component and for a plurality of maximum buffer capacities of the at least one machine of the production line.

25. The system of claim 23, wherein the system is configured to determine a dynamic optimal buffer capacity of at least one machine of the production line for the production process based on the simulation, by optimizing a maximum buffer capacity of the at least one machine with respect to at least one of 1) a level of micro-stops or speed mismatches of machines of the production line, 2) speed of machines of the production line, and 3) an operation phase, wherein the dynamic optimal buffer capacity changes over time based on the at least one of 1) an actual level of micro-stops or speed mismatches of machines of the production line, 2) speed of machines of the production line, and 3) an operation phase.

26. The system of claim 23, wherein the system comprises the plurality of machines of the production line,
wherein the plurality of machines comprise at least one of a crimper, a buffer, a combiner, a cut and turn unit, a packer line, a wrapper and a bundler, and
wherein open platform communication, OPC, unified architecture, UA, and tobacco machine communication, TMC, standards are used to interface and interact with the plurality of machines.

27. The system of claim 23, wherein the digital twin speed management component, the speed management component and the simulation component are executed as modules in a containerized environment on an edge device.
